(19) United States
(12) Patent Application Publication
(10) Pub. No.: US 2026/0338922 A1
(43) Pub. Date: Oct. 29, 2026

(54) LIDAR

(71) Applicant: TENSOR AI SINGAPORE PTE. LTD., SINGAPORE (SG)

(72) Inventors: Yizhou Shan, Shenzhen (CN); Jianxiong Xiao, Shenzhen (CN); Kefan Hu, Shenzhen (CN); Xuhui Tao, Shenzhen (CN); Wenxiang Wang, Shenzhen (CN)

(73) Assignee: TENSOR AI SINGAPORE PTE. LTD., SINGAPORE (SG)

(21) Appl. No.: 19/192,451

(22) Filed: Apr. 29, 2025

(51) Int. Cl. G01S 7/481

(52) U.S. Cl. CPC G01S 7/4817; G01S 7/4813

(57) ABSTRACT

The disclosure provides a LiDAR, includes a laser transceiver module configured to: emit a plurality of collimated laser beams arranged in an emission plane; and detect a plurality of reflected beams returning from an object; a dual-axis scanning assembly, rotatable about a first axis, including: a reflective element; and an actuator mechanism coupled to the reflective element, configured to: tilt the reflective element about a second axis, the primary and secondary axes being orthogonally oriented; maintain the emission plane of the collimated beams parallel to the first axis during operation; wherein the reflective element is operable to: effectuate simultaneous rotation about the first axis and tilting about the second axis to generate a three-dimensional point cloud through sequential reflection of the collimated beams; and redirect the reflected beams toward the laser transceiver module for detection; and a control unit configured to regulate rotational motion of the dual-axis assembly.

### TECHNICAL FIELD

The disclosure relates to the field of LiDAR (Light Detection and Ranging), in particular to a LiDAR.

### BACKGROUND

The essence of laser 3D imaging is parallel laser ranging, where the distance image of a target is obtained based on the time difference between the transmitted laser signal and the echo signal, acquired either directly or indirectly. Scanning LiDAR consists of a single-point laser coherent or incoherent ranging system paired with a beam scanning device and represents a relatively mature 3D imaging LiDAR technology to date. Scanning LiDAR necessitates rapid ranging for each point, with the beam scanning device controlling the orientation of the LiDAR optical axis in different directions to sequentially measure the distances to various points on the target, while simultaneously recording the azimuth and elevation angles of the beam direction. This enables the acquisition of a target's distance-angle-angle image.

Automotive LiDAR, which provides necessary 3D point cloud data for autonomous vehicles, typically requires a 360° horizontal field of view and a certain vertical field of view. Scanning LiDAR employs motor-driven mirror rotation and utilizes the principles of geometric optics to achieve beam deflection, offering a large scanning field of view and high scanning efficiency. It is the most common, widely used, and mature automotive LiDAR technology in recent years. “Mechanical rotation+linear array transceiver arrangement” is a typical representative of this scanning method: mechanical rotation in the horizontal direction achieves a 360° field of view, while in the vertical direction, a linear array arrangement of laser transceiver modules, matched with parallel detection modules, forms multi-line scanning within a plane perpendicular to the linear array arrangement direction. Specific angles exist between the various scanning beams, thereby achieving a certain degree of uniform or non-uniform angular coverage in the linear arrangement direction. This scanning method reduces motion in one dimension, enabling the acquisition of the target's distance image with scanning along only one dimension, significantly enhancing the system's scanning efficiency. However, this solution requires a dense vertical array arrangement of high-frequency laser emitters within the upper compartment structure of the scanning LiDAR, with precise alignment of the transmit and receive optical modules for each channel. Crosstalk between different ranging channels necessitates extremely high assembly and installation accuracy. Scanning LiDAR thus features a large overall size, high moment of inertia, high power consumption, and high cost, with stringent requirements for cooling, processing, and other aspects.

### SUMMARY

The disclosure provides a LiDAR that addresses issues such as the large overall size, high moment of inertia, high power consumption, and high cost of scanning LiDAR.

An embodiment of the disclosure provides a LiDAR, including a laser transceiver module, a reflective assembly, an actuator mechanism, and a control unit. The laser transceiver module is configured to emit a plurality of collimated laser beams lying within a emission plane; and detect a plurality of reflected beams reflected from an object; a reflective assembly, rotatable about a first axis, comprising: a reflective element; The actuator mechanism is configured to control the reflective element to flip about a second axis, the first axis and the second axis are mutually perpendicular; when the plurality of collimated laser beams are incident on the reflective element, the plane in which the plurality of collimated laser beams are located is parallel to the first axis; the reflective element is capable of rotating about the first axis while simultaneously flipping about the second axis to reflect the collimated laser beams, so as to form a three-dimensional point cloud of the collimated laser beams. The reflective element is further configured to reflect the reflected beams, such that the reflected beams are received by the laser transceiver module. The control unit, is configured to control the rotation of the reflective assembly about the first axis.

In the aforementioned LiDAR, when the collimated laser beams are incident on the reflective element, the reflective element reflects the collimated laser beams along both the first axis and the second axis by rotating around the first axis while flipping around the second axis, thereby achieving multi-line scanning. If the reflective element rotates 360° around the first axis while flipping 360° around the second axis, 360° circumferential scanning can be achieved, thereby forming a 360° three-dimensional point cloud. The overall structure of the LiDAR breaks through the constraints of traditional multi-line LiDAR configurations, making it applicable to LiDAR of different systems including incoherent and coherent systems. It features a low moment of inertia, simple structure, high reliability, and ease of integration and miniaturization, and has good development prospects in the field of automotive LiDAR.

### BRIEF DESCRIPTION OF THE DRAWINGS

In order to more clearly illustrate the technical solutions in the embodiments of the disclosure or in the prior art, the drawings required for describing the embodiments or the prior art will be briefly introduced below. It is apparent that the drawings described below are merely some embodiments of the disclosure. For those skilled in the art, without creative efforts, other drawings can be obtained based on the structures shown in these drawings.

FIG. 1 is a schematic diagram of a LiDAR provided in an embodiment of the disclosure.

FIG. 2 is a schematic diagram of the internal structure of the LiDAR provided in an embodiment of the disclosure.

FIG. 3 is a schematic diagram of the internal structure of the laser transceiver module of the LiDAR shown in FIG. 1.

FIG. 4 is a schematic diagram of the laser transceiver module of the LiDAR shown in FIG. 1.

FIG. 5 is a schematic diagram of the internal structure of the reflective assembly of the LiDAR shown in FIG. 1.

FIG. 6 is a cross-sectional schematic diagram of the reflective element of the LiDAR shown in FIG. 1.

FIG. 7 is a schematic diagram of the internal structure of the processing assembly of the LiDAR shown in FIG. 1.

FIG. 8 is a diagram illustrating the connection relationship between the processing assembly and the laser transceiver module of the LiDAR shown in FIG. 1.

The realization of the objectives, functional features, and advantages of the disclosure will be further described with reference to the embodiments and the accompanying drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the present application and are not intended to limit the present application. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the present application are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the present application.

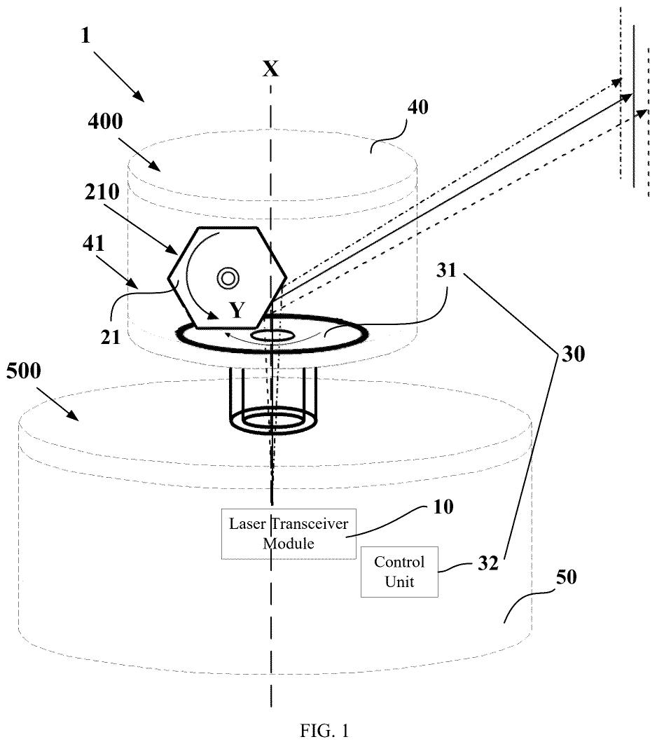

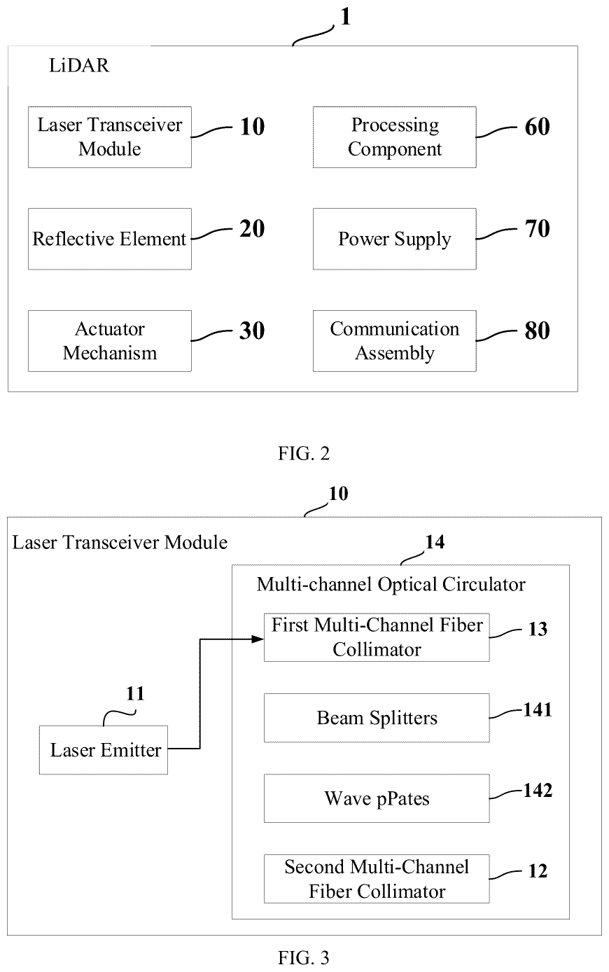

Referring to FIGS. 1 to 3, FIG. 1 is a schematic diagram of a LiDAR provided in an embodiment of the disclosure, FIG. 2 is a schematic diagram of the internal structure of the LiDAR provided in an embodiment of the disclosure, and FIG. 3 is a schematic diagram of a laser transceiver module provided in an embodiment of the disclosure. The LiDAR 1 comprises a laser transceiver module 10, a reflective assembly 20, an actuator mechanism 30, a first housing 40, and a second housing 50. Among them, the laser transceiver module 10, the reflective assembly 20, and the actuator mechanism 30 are accommodated within the first housing 40 or the second housing 50.

The first housing 40 and the second housing 50 are spaced apart along a first axis X and fixedly connected. The first housing 40 is provided with a first accommodating cavity 400, and the second housing 50 is provided with a second accommodating cavity 500. The first accommodating cavity 400 and the second accommodating cavity 500 are connected. In this embodiment, both the first housing 40 and the second housing 50 are cylindrical. The axis of the first housing 40 coincides with the axis of the second housing 50, and the axes of the first housing 40 and the second housing 50 are parallel to the first axis X. The side of the first housing 40 is provided with an annular window 41.

The laser transceiver module 10 is configured to emit a plurality of collimated laser beams and receive a plurality of reflected beams formed by the reflection of the plurality of collimated laser beams off an object. The plurality of collimated laser beams are located in the same plane, that is, they are arranged in a linear array. The plurality of collimated laser beams exit the LiDAR 1 through the annular window 41, and the plurality of reflected beams enter the LiDAR 1 through the annular window 41. In this embodiment, there is a certain angle between adjacent collimated laser beams among the plurality of collimated laser beams.

In this embodiment, the laser transceiver module 10 is housed within a second accommodation cavity 500 and comprises a laser emitter 11 and a multi-channel optical circulator 14. The laser emitter 11 serves as the laser emission source, capable of emitting frequency-modulated continuous-wave laser light or pulsed laser light. The multi-channel optical circulator 14 includes a first multi-channel fiber collimator 13 and a second multi-channel fiber collimator 12. Among them, the number of channels in the first multi-channel fiber collimator 13 is the same as the number of channels in the second multi-channel fiber collimator 12. The laser emitter 11 is connected to the first multi-channel fiber collimator 13, and the original light beam emitted by the laser emitter 11 passes through the first multi-channel fiber collimator 13 to form a plurality of collimated laser beams. Among these collimated laser beams, there is an angle between each adjacent pair of collimated laser beams, and the size of the angle can be adjusted based on the spot size and overlap degree of the collimated laser beams. The number of collimated laser beams among the plurality of collimated laser beams is the same as the number of channels in the first multi-channel fiber collimator 13. The multi-channel optical circulator 14 forms a plurality of transmit channels and a plurality of receive channels, with the plurality of collimated laser beams being injected into the reflective assembly 20 along the transmit channels, and a plurality of reflected beams being injected into the second multi-channel fiber collimator 12 along the receive channels. Herein, the number of transmit channels is the same as the number of receive channels, and each transmit channel corresponds to a respective receive channel. It is understandable that the first multi-channel fiber collimator 13 is used for emitting the plurality of collimated laser beams, while the second multi-channel fiber collimator 12 is used for receiving the plurality of reflected beams. The number of collimated laser beams, the number of reflected beams, the number of transmit channels, and the number of receive channels are all the same, with each laser beam corresponding to a respective transmit channel and each echo beam corresponding to a respective receive channel.

The multi-channel optical circulator 14 further includes a plurality of beam splitters 141 and a plurality of wave plates 142. The plurality of beam splitters 141 and the plurality of wave plates 142 are arranged between the first multi-channel fiber collimator 13 and the second multi-channel fiber collimator 12 in a specific arrangement to form the plurality of transmit channels and the plurality of receive channels. In this embodiment, each transmit channel partially overlaps with its corresponding receive channel. That is, the transmit channels and receive channels are coaxial for transmission and reception, thereby achieving matching between the transmit channels and the receive channels. Among them, the beam splitters 141 include but are not limited to polarization beam splitters, depolarization beam splitters, etc., and the wave plates 142 include but are not limited to half-wave plates, quarter-wave plates, etc. The types of beam splitters 141 and wave plates 142, as well as their arrangement, can be set according to the number of collimated laser beams and are not limited herein.

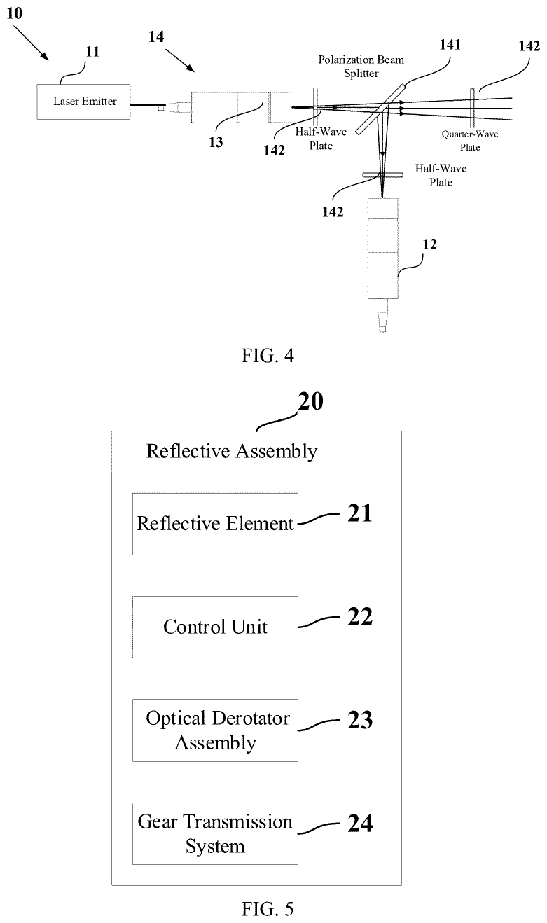

Taking the laser transceiver module 10 shown in FIG. 4 as an example, both the first multi-channel fiber collimator 13 and the second multi-channel fiber collimator 12 are three-channel fiber collimators, and they are arranged vertically. The original light beam emitted by the laser emitter 11 is a frequency-modulated continuous wave with a wavelength band of 1550 nm. The original light beam passes through the first multi-channel fiber collimator 13 to form three collimated laser beams with a polarization degree greater than 20 dB. The three collimated laser beams lie on the same plane, with a beam diameter of 10 mm, and there is an angle of 0.2° between each adjacent pair of the three collimated laser beams. Among them, the laser beam of the first channel is deflected by +0.2°, the laser beam of the second channel is deflected by 0°, and the laser beam of the third channel is deflected by −0.2°. Although there is a certain angle between each adjacent pair of collimated laser beams, this angle can be adjusted according to the density of the collimated laser beams and typically ranges from 0.1° to 0.2°, thus having no significant impact on the polarization performance of the multi-channel optical circulator 14.

The multi-channel optical circulator 14 comprises a polarization beam splitter, two half-wave plates, and a quarter-wave plate. The two half-wave plates correspond to a first multi-channel fiber collimator 13 and a second multi-channel fiber collimator 12, respectively. The two half-wave plates are disposed at the exit of the first multi-channel fiber collimator 13 and the entrance of the second multi-channel fiber collimator 12, respectively. The polarization beam splitter is disposed at the intersection of the line on which the first multi-channel fiber collimator 13 lies and the line on which the second multi-channel fiber collimator 12 lies. The quarter-wave plate is disposed on the side of the polarization beam splitter facing away from the first multi-channel fiber collimator 13. It is understood that the first multi-channel fiber collimator 13, the half-wave plate corresponding to the first multi-channel fiber collimator 13, the polarization beam splitter, and the quarter-wave plate are located on the same straight line; the polarization beam splitter, the half-wave plate corresponding to the second multi-channel fiber collimator 12, and the second multi-channel fiber collimator 12 are located on the same straight line. In this embodiment, in the direction away from the first housing 40, the quarter-wave plate, the polarization beam splitter, the half-wave plate corresponding to the first multi-channel fiber collimator 13, and the first multi-channel fiber collimator 13 are arranged sequentially along a first axis X. In the direction away from the polarization beam splitter, the half-wave plate corresponding to the second multi-channel fiber collimator 12 and the second multi-channel fiber collimator 12 are arranged sequentially in a direction perpendicular to the first axis X. Three transmitting channels are formed among the first multi-channel fiber collimator 13, the half-wave plate corresponding to the first multi-channel fiber collimator 13, the polarization beam splitter, and the quarter-wave plate. Three receiving channels are formed among the quarter-wave plate, the polarization beam splitter, the half-wave plate corresponding to the second multi-channel fiber collimator 12, and the second multi-channel fiber collimator 12. It is understood that each transmitting channel partially overlaps with its corresponding receiving channel between the quarter-wave plate and the polarization beam splitter.

Three collimated laser beams emitted from the first multi-channel fiber collimator 13 first pass through the half-wave plate corresponding to the first multi-channel fiber collimator 13, then through the polarization beam splitter, and exit from the quarter-wave plate. Three parallel return collimated laser beams incident on the quarter-wave plate have their polarization states rotated to vertical polarization by rotating the quarter-wave plate, and then pass through the polarization beam splitter and the half-wave plate corresponding to the second multi-channel fiber collimator 12 in sequence before entering the second multi-channel fiber collimator 12.

The polarization beam splitter has a diameter of 12.7 mm, a thickness of 2 mm, a design wavelength of 1550 nm, a dimensional tolerance of ±0.1 mm, a surface quality of 60/40, a light-passing aperture greater than 80%, wavefront distortions of transmitted and reflected light both not exceeding λ/8@633 nm, a beam deviation of less than 0.5 minutes, a transmission extinction ratio greater than 1000:1, a reflection extinction ratio greater than 200:1, a polarizing beam-splitting dielectric film (PBS) coated on the beam-splitting surface for 1550 nm, and an anti-reflection film coated on the incident surface for 1550 nm with R<0.25% @1550 nm. In some feasible embodiments, the parameters of the polarization beam splitter can be adjusted according to actual conditions and are not limited to these values.

The actuator mechanism 30 is used to control the reflective assembly 20 to rotate around the first axis X. In this embodiment, the actuator mechanism 30 includes an electrically connected turntable 31 and a controller 32. The controller 32 is accommodated in the second accommodation cavity 500, with one end of the turntable 31 connected to the controller 32 and the other end protruding into a first accommodation cavity 400. The reflective assembly 20 is fixed to the turntable 31, and the controller 32 is used to control the rotation of the turntable 31 around the first axis X. The direction of rotation includes clockwise and counterclockwise rotations. It is understood that since the reflective assembly 20 is fixed to the turntable 31, when the controller 32 controls the turntable 31 to rotate around the first axis X, the reflective assembly 20 rotates along with the turntable 31. Herein, the first axis X is the central axis of the turntable 31. Preferably, the first axis X coincides with the axes of the first housing 40 and the second housing 50. In this embodiment, the controller 32 can control the turntable 31 to rotate 360° around the first axis X, enabling the LiDAR 1 to achieve 360° circumferential linear array laser scanning. Herein, the rotational speed of the turntable 31 controlled by the controller 32 to rotate around the first axis X is a first rotational speed, which can be set according to the actual application scenario. The higher the first rotational speed of the turntable 31, the faster the LiDAR 1 perceives the external environment.

The reflective component 20 is accommodated within a first accommodating cavity 400. The reflective component 20 is rotatable about a first axis X. It is understandable that the rotational speed of the reflective component 20 around the first axis X is the same as a first rotational speed of a turntable 31. In this embodiment, the reflective component 20 comprises a reflective element 21 and a control unit 22, wherein the control unit 22 is configured to control the reflective element 21 to flip about a second axis Y. The direction of flipping includes clockwise flipping and counterclockwise flipping. Herein, the first axis X and the second axis Y are perpendicular to each other. Preferably, the control unit 22 controls the reflective element 21 to perform a 360° flip around the second axis Y. Herein, the rotational speed at which the control unit 22 controls the reflective element 21 to flip around the second axis Y is a second rotational speed, which can be set according to practical application scenarios. The higher the second rotational speed of the reflective element 21, the faster the perception speed of the LiDAR 1 towards the external environment. In this embodiment, the reflective element 21 is a regular prism, and the second axis Y is the central axis of the reflective element 21. It is understandable that when the reflective element 21 rotates around the first axis X, the second axis Y rotates along with the rotation of the reflective element 21. That is, the second axis Y is not fixed. The regular prism includes but is not limited to a regular hexagonal prism, a regular octagonal prism, and the like. In some feasible embodiments, the reflective element 21 can also be a pyramid. Regardless of whether the reflective element 21 is a regular prism or a pyramid, all sides of the reflective element 21 are reflective mirrors, and the sides of the reflective element 21 can reflect light beams to deflect them. Only placing the reflective component 20 in the first accommodating cavity 400 can reduce the overall weight of components placed in the first accommodating cavity 400, making the turntable 31 carry a lighter load when rotating and rotate more smoothly. Meanwhile, it can also reduce adverse effects such as vibration and displacement on components caused by the rotation of the turntable 31.

The reflective element 21 comprises a plurality of reflective surfaces 210. A plurality of collimated laser beams propagate from a second accommodating cavity 500 to the first accommodating cavity 400 along a plurality of emission channels and are incident on the reflective element 21, and the reflective surfaces 210 reflect the plurality of collimated laser beams so that they exit through an annular window 41. When reflected beams are incident on the reflective element 21 from the annular window 41, the reflective surfaces 210 are also configured to reflect the reflected beams so that they propagate from the first accommodating cavity 400 to the second accommodating cavity 500 and are received by a laser transceiver module 10. When the plurality of collimated laser beams are incident on the reflective element 21, the plane in which the plurality of collimated laser beams lie is parallel to the first axis X. The reflective element 21 rotates around the first axis X while flipping around the second axis Y for reflecting collimated laser beams to form a three-dimensional point cloud of collimated laser beams. It is understandable that the reflective element 21 rotates around the first axis X and flips around the second axis Y simultaneously.

When the reflective element 21 rotates around the first axis X, it is configured to reflect collimated laser beams so that the collimated laser beams form a plurality of first scan lines around the first axis X. When the reflective element 21 flips around the second axis Y, it is configured to reflect collimated laser beams so that the collimated laser beams form a plurality of second scan lines around the second axis Y. The plurality of first scan lines and the plurality of second scan lines collectively form a three-dimensional point cloud. It is understandable that the first scan lines formed by the collimated laser beams are perpendicular to the first axis X, and the second scan lines formed by the collimated laser beams are perpendicular to the second axis Y.

The scanning frequency of the reflective element 21 can be calculated according to a first formula. Specifically, the first formula is: f_{scan}=ω̅Nₘ. Herein, f_{scan} represents the scanning frequency, ω̅ represents the second rotational speed, and Nₘ represents the number of reflective surfaces 210. In this embodiment, ω̅ refers to the number of revolutions per second of the reflective element 21 flipping 360° around the second axis Y within one second, and f_{scan} represents the equivalent number of revolutions per second of the reflective element 21 flipping 360° around the second axis Y within one second. For example, when ω̅ is 100 revolutions per second and is Nₘ 8, it is equivalent to the reflective element 21 flipping 800 times within one second.

The number of scan lines per frame of the LiDAR 1 can be calculated according to a second formula. Specifically, the second formula is:

$${N}_{p} = \frac{{f}_{scan}}{{f}_{FRAME}} = \frac{ϖ {N}_{m}}{{f}_{FRAME}} .$$

Wherein, Nₚ represents the number of scan lines per frame, and f_{FRAME} represents the frame rate of the LiDAR 1. In this embodiment, the frame rate indicates that the LiDAR 1 customizes and packages several scanning cycles into a data packet for transmission.

The number of lines for the first scan line of the reflective element 21 can be calculated according to a third formula. The number of lines for the first scan line is also the number of scan lines in the horizontal direction. Specifically, the third formula is: N=nNₚ. Wherein, N represents the number of lines for the first scan line of the reflective element 21, and n represents the number of channels of the first multi-channel fiber collimator 13.

The number of lines for the second scan line of the reflective element 21 can be calculated according to a fourth formula. Specifically, the fourth formula is:

$${N}_{r} = \frac{{f}_{emit} η}{{N}_{p}} .$$

Wherein, Nᵣ represents the number of lines for the second scan line of the reflective element 21, which is also the number of scan lines in the vertical direction. fₑₘᵢₜ represents the pulse repetition frequency (PRF) of the laser emitter 11, η represents the duty cycle, and fₑₘᵢₜ η represents the actual emission PRF of the laser emitter 11.

The three-dimensional point cloud formed by a plurality of first scan lines and a plurality of second scan lines can be represented as: N pixels×Nᵣ pixels. It is understandable that in the three-dimensional point cloud, the number of point clouds in the horizontal direction is determined by the number of reflective surfaces 210, the second rotational speed, and the number of channels of the first multi-channel collimator 13; the number of point clouds in the vertical direction is determined by the PRF and duty cycle of the laser emitter 11.

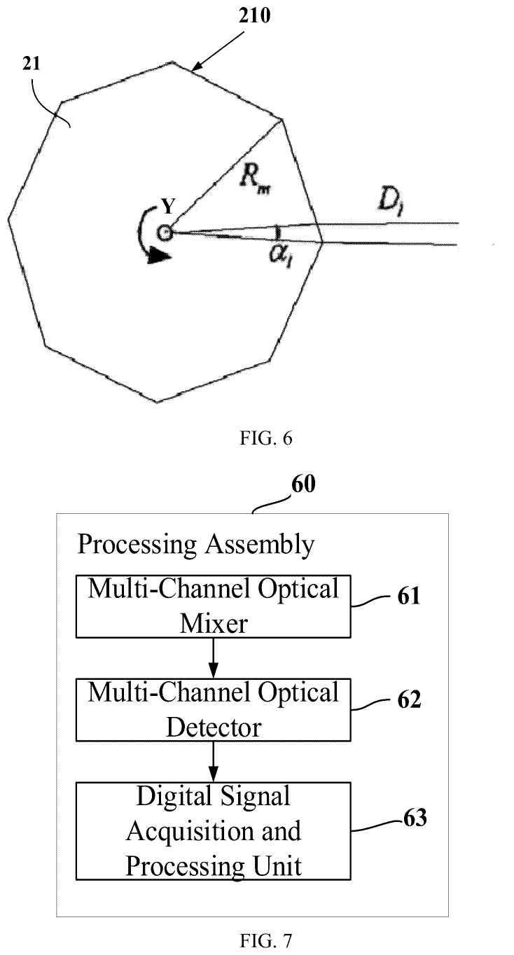

Taking the cross-section of the reflective element 21 shown in FIG. 6 as an example, the inscribed radius of the reflective element 21 is Rₘ, and a plurality of collimated laser beams incident on the reflective surfaces 210 form spots with a width of Dₗ on the reflective surfaces 210.

Assuming that the width Dₗ is much smaller than the inscribed radius Rₘ, then the angle αₗ subtended by the plurality of collimated laser beams to the central axis of the reflective element 21 can be calculated according to a fifth formula. Specifically, the fifth formula is:

$${α}_{1} = \frac{{D}_{1} \times 180 °}{π {R}_{m}} .$$

The effective rotation angle of each αᵥ reflective surface 210 can be calculated according to a sixth formula:

$${α}_{v} = {α}_{n} - {α}_{1} = \frac{360 °}{{N}_{m}} - \frac{{D}_{1} \times 180 °}{π {R}_{m}} .$$

Specifically, the sixth formula is: [not provided]. Wherein, Nₘ represents the number of reflective surfaces 210, and αₙ represents the angle subtended by the reflective surfaces 210 to the central axis.

The effective field of view angle formed θᵥ when the laser beam is reflected by the reflective surface 210 and exits through the annular window 41, i.e., the vertical field of view angle of the LiDAR 1, can be calculated according to a seventh formula. Specifically, the seventh formula is:

$${θ}_{v} = \frac{720 °}{{N}_{m}} - \frac{{D}_{1} \times 360 °}{π {R}_{m}} .$$

Therefore, the vertical angular resolution of LiDAR 1 is

$$\frac{{θ}_{v}}{{N}_{r}} .$$

Since the controller 32 controls the turntable 31 to rotate at 360°, the horizontal field of view angle of the LiDAR 1 is 360°. Therefore, the horizontal angular resolution of the LiDAR 1 is

$$\frac{360 °}{N} .$$

For example, if the number of Nₘ reflective surfaces 210 of the reflective element 21 is 8 and the second rotational speed of the reflective element 21 is 6000 RPM, ω̅ is 100 revolutions per second, then the scanning frequency f_{scan} is 800 Hz. If the frame rate of the LiDAR 1 f_{FRAME} is 10 Hz, then the number of scan lines Nₚ per frame is 80. If the number of channels N in the first multi-channel fiber collimator 13 is 3, then the number of lines fₑₘᵢₜ in the first scan line is 240 kHz. If the repetition frequency of the laser emitter 11 is 200 kHz, meaning the laser emitter 11 emits 200,000 times per frame with a duty cycle η of 80%, then the laser emitter 11 actually emits 160,000 times per frame, and the number of lines in the second scan line Nᵣ is 2,000. Therefore, the three-dimensional point cloud formed jointly by the first scan line and the second scan line is: 240 pixels×2000 pixels. Correspondingly, the horizontal field of view is 360°, and the horizontal angular resolution is 1.5°. If the inscribed radius of the reflective element 21 Rₘ is 100 mm, then the vertical field of view θᵥ is approximately 50°, and the vertical angular resolution is 0.025°.

Referring to FIG. 5 in conjunction, which is a schematic diagram illustrating the internal structure of the reflective assembly provided in an embodiment of the disclosure. The reflective assembly 20 further comprises an optical derotator assembly 23 disposed on the optical path between the laser transceiver module 10 and the reflective element 21. It can be understood that before the laser beam is incident on the reflective element 21, it needs to pass through the optical derotator assembly 23, which is used for image derotation compensation. The optical derotator assembly 23 can rotate around a first axis X. The rotation speed of the optical derotator assembly 23 around the first axis X is compatible with the rotation speed of the reflective element 21 around the first axis X. In this embodiment, the rotation speed of the optical derotator assembly 23 around the first axis X can be half of the rotation speed of the reflective element 21 around the first axis X. For example, if the first rotational speed is 3600°/second, then the rotation speed of the optical derotator assembly 23 is 1800°/second. In some feasible embodiments, the relationship between the rotation speed of the optical derotator assembly 23 around the first axis X and the rotation speed of the reflective element 21 around the first axis X can also be set according to actual conditions and is not limited herein. In this embodiment, the optical derotator assembly 23 is a Brehon prism. For example, the optical derotator assembly 23 is made of Ziesel glass, specifically flint glass material with the model SF11. The refractive index of the optical derotator assembly 23 in the 1550 nm band is 1.74, and 1550 nm anti-reflection films are coated on two non-totally reflecting surfaces. The width of the optical derotator assembly 23 is 15 mm, and the height is 20 mm. In some feasible embodiments, the parameters of the optical derotator assembly 23 can be adjusted according to actual conditions and are not limited to this.

The reflective assembly 20 further comprises a gear transmission system 24, which is connected to both the reflective element 21 and the optical derotator assembly 23. When the reflective element 21 rotates around the first axis X, it drives the gear transmission system 24 to operate, which in turn drives the optical derotator assembly 23 to rotate around the first axis X.

The LiDAR 1 further comprises a processing assembly 60. The processing assembly 60 is housed in the second accommodation cavity 500 and is electrically connected to the laser transceiver module 10. The processing assembly 60 is configured to process the laser beam and the echo beam to form point cloud data.

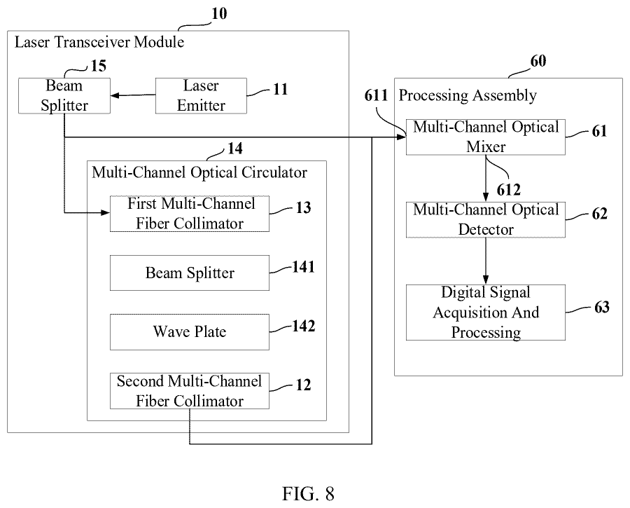

Referring to FIGS. 7 and 8 in conjunction. FIG. 7 is a schematic diagram illustrating the internal structure of a processing assembly provided in an embodiment of the disclosure, and FIG. 8 is a diagram illustrating the connection relationship between the processing assembly and a laser transceiver module provided in an embodiment of the disclosure. The processing assembly 60 comprises a multi-channel optical mixer 61, a multi-channel optical detector 62, and a digital signal acquisition and processing unit 63. Among them, the multi-channel optical mixer 61 is connected to the multi-channel optical detector 62, and the multi-channel optical detector 62 is connected to the digital signal acquisition and processing unit 63. The multi-channel optical mixer 61 collects collimated laser beams emitted by a laser emitter 11 and reflected beams received by a second multi-channel fiber collimator 12, and performs coherent mixing on the collimated laser beams and reflected beams to obtain mixed beams. The multi-channel optical detector 62 converts the mixed beams into corresponding electrical signals. The digital signal acquisition and processing unit 63 is also connected to a control unit 22 and a controller 32, respectively. The digital signal acquisition and processing unit 63 processes the electrical signals and combines data such as the rotation angle of the reflective element 21 fed back by the control unit 22 and the rotation angle of a turntable 31 fed back by the controller 32 to obtain point cloud data.

In this embodiment, the laser transceiver module 10 further comprises a beam splitter 15 disposed between the laser emitter 11 and a first multi-channel fiber collimator 13. The multi-channel optical mixer 61 includes a receiving end 611 and an output end 612. The receiving end 611 of the multi-channel optical mixer 61 is connected to the beam splitter 15 and the second multi-channel fiber collimator 12, respectively, and the output end 612 of the multi-channel optical mixer 61 is connected to the multi-channel optical detector 62. It is understood that the beam splitter 15 splits the original beam emitted by the laser emitter 11 into two paths. One path of the beam is directed to the first multi-channel fiber collimator 13 to form a plurality of collimated laser beams, and the other path of the beam is directed to the receiving end 611 of the multi-channel optical mixer 61.

The LiDAR 1 further includes a power supply assembly 70 and a communication assembly 80. The power supply assembly 70 and the communication assembly 80 can be accommodated in a first accommodation cavity 400, can be accommodated in the second accommodation cavity 500, or can be disposed at the junction between a first housing 40 and a second housing 50. Among them, the power supply assembly 70 is connected to the communication assembly 80 and the control unit 22, respectively, for providing power to the communication assembly 80 and the control unit 22. The communication assembly 80 is communicatively connected to the control unit 22, the controller 32, and the processing assembly 60 for providing data communication. In this embodiment, the power supply assembly 70 is a wireless power supply device, and the communication assembly 80 is a wireless communication device. In some feasible embodiments, the power supply assembly 70 can also be connected to the laser transceiver module 10, an actuator mechanism 30, or the processing assembly 60 for providing power thereto.

In the aforementioned embodiments, through the cooperation between the reflective element that can flip around a second axis and the turntable, when a laser beam is incident on the reflective element, the reflective element reflects the laser beam along a first axis and along a second axis by rotating around the first axis while flipping around the second axis, thereby achieving multi-line scanning. When the reflective element, fixed on the turntable, rotates 360° around the first axis while flipping 360° around the second axis, 360° circumferential scanning can be achieved, thereby forming a 360° three-dimensional point cloud. Based on the collimated laser beams and reflected beams, and synchronized with the angles of rotation and flipping of the reflective element, 360° point cloud data can be obtained. The overall structure of the LiDAR breaks through the constraints of the traditional multi-line LiDAR upper and lower chamber structural configuration and can be applied to LiDARs of different systems, including incoherent and coherent systems. It has small rotational inertia, a simple structure, high reliability, and is easy to integrate and miniaturize, having good development prospects in the field of automotive LiDARs.

It is apparent that those skilled in the art can make various modifications and variations to the disclosure without departing from the spirit and scope thereof. Thus, if these modifications and variations of the disclosure fall within the scope of the claims and their equivalents, the disclosure is also intended to encompass these modifications and variations.

The above-enumerated examples are merely preferred embodiments of the disclosure and cannot, of course, be used to limit the scope of the claims of the disclosure. Therefore, equivalent variations made in accordance with the claims of the disclosure still fall within the scope covered by the disclosure.

1. A LiDAR, comprising:
a laser transceiver module, configured to emit a plurality of collimated laser beams lying within an emission plane; and detect a plurality of reflected beams reflected from an object;
a reflective assembly, rotatable about a first axis, comprising:
a reflective element; and
an actuator mechanism, the actuator mechanism configured to control the reflective element to flip about a second axis, the first axis and the second axis being mutually perpendicular; when the plurality of collimated laser beams are incident on the reflective element, the plane in which the plurality of collimated laser beams are located is parallel to the first axis; the reflective element capable of rotating about the first axis while simultaneously flipping about the second axis to reflect the collimated laser beams, so as to form a three-dimensional point cloud of the collimated laser beams; the reflective element being further configured to reflect the reflected beams, such that the reflected beams are received by the laser transceiver module; and
a control unit, configured to control the rotation of the reflective assembly about the first axis.

2. The LiDAR according to claim 1, wherein when the reflective element rotates about the first axis, the reflective element is configured to reflect the collimated laser beams such that the collimated laser beams form a plurality of first scan lines about the first axis; when the reflective element flips about the second axis, the reflective element is configured to reflect the collimated laser beams such that the collimated laser beams form a plurality of second scan lines about the second axis, wherein the plurality of first scan lines and the plurality of second scan lines intersect to form the three-dimensional point cloud.

3. The LiDAR according to claim 1, wherein the reflective element is a regular prism, wherein the second axis is the central axis of the reflective element.

4. The LiDAR according to claim 1, wherein the reflective assembly further comprises an optical derotator assembly disposed on an optical path between the laser transceiver module and the reflective element; the optical derotator assembly is rotatable about the first axis, and a rotation speed of the optical derotator assembly about the first axis is compatible with that of the reflective element about the first axis.

5. The LiDAR according to claim 4, wherein the reflective assembly further comprises a gear transmission system operatively coupled to both the reflective element and the optical derotator assembly; when the reflective element rotates about the first axis, the reflective element drives the gear transmission system to operate, such that the optical derotator assembly rotates about the first axis.

6. The LiDAR according to claim 1, further comprising a first housing, and a second housing spaced apart along the first axis, the first housing defining a first accommodation cavity, the second housing defining a second accommodation cavity, the first accommodation cavity and the second accommodation cavity being communicated; the laser transceiver module being accommodated in the second accommodation cavity, and the reflective assembly being accommodated in the first accommodation cavity.

7. The LiDAR according to claim 6, wherein the control unit comprises a turntable and controller accommodated in the second accommodation cavity, one end of the turntable is connected to the controller and other end of the turntable extends through the first accommodation cavity, the reflective assembly is fixed to the turntable; the controller is configured to control the rotation of the turntable about the first axis, with the first axis being an axis of the turntable.

8. The LiDAR according to claim 6, further comprising a processing component accommodated in the second accommodation cavity, the processing component being electrically coupled to the laser transceiver module, the processing component being configured to process the collimated laser beams and the reflected beams to form point cloud data.

9. The LiDAR according to claim 1, wherein the laser transceiver module includes a laser emitter and a multi-channel optical circulator, the multi-channel optical circulator defines a plurality of transmit channels and a plurality of receive channels; the multi-channel optical circulator includes a first multi-channel fiber collimator, and a second multi-channel fiber collimator, the original laser beams emitted by the laser emitter passing through the first multi-channel fiber collimator to form the plurality of collimated laser beams, the plurality of collimated laser beams are incident on the reflective element along the plurality of transmit channels, and the plurality of reflected beams are incident on the second multi-channel fiber collimator along the plurality of receive channels.

10. The LiDAR according to claim 9, wherein a number of the plurality of transmit channels equals a number of the plurality of receive channels, each transmit channel is paired with a corresponding receive channel in one-to-one correspondence, each transmit channel partially overlapping with the corresponding receive channel.

11. A LiDAR system, comprising:
a laser transceiver module configured to:
emit a plurality of collimated laser beams arranged in an emission plane; and
detect a plurality of reflected beams returning from an object;
a dual-axis scanning assembly, rotatable about a first axis, including:
a reflective element; and
an actuator mechanism, coupled to the reflective element, the actuator mechanism configured to:
tilt the reflective element about a second axis, the primary and secondary axes being orthogonally oriented;
maintain the emission plane of the collimated beams parallel to the first axis during operation;
wherein the reflective element is operable to:
effectuate simultaneous rotation about the first axis and tilting about the second axis to generate a three-dimensional point cloud through sequential reflection of the collimated beams; and
redirect the reflected beams toward the laser transceiver module for detection; and
a control unit configured to regulate rotational motion of the dual-axis assembly about the first axis.

12. The LiDAR according to claim 11, wherein when the reflective element rotates about the first axis, the reflective element is configured to reflect the collimated laser beams such that the collimated laser beams form a plurality of first scan lines about the first axis; when the reflective element flips about the second axis, the reflective element is configured to reflect the collimated laser beams such that the collimated laser beams form a plurality of second scan lines about the second axis, wherein the plurality of first scan lines and the plurality of second scan lines intersect to form the three-dimensional point cloud.

13. The LiDAR according to claim 11, wherein the reflective element is a regular prism, wherein the second axis is the central axis of the reflective element.

14. The LiDAR according to claim 11, wherein the reflective assembly further comprises an optical derotator assembly disposed on an optical path between the laser transceiver module and the reflective element; the optical derotator assembly is rotatable about the first axis, and a rotation speed of the optical derotator assembly about the first axis is compatible with that of the reflective element about the first axis.

15. The LiDAR according to claim 14, wherein the reflective assembly further comprises a gear transmission system operatively coupled to both the reflective element and the optical derotator assembly; when the reflective element rotates about the first axis, the reflective element drives the gear transmission system to operate, such that the optical derotator assembly rotates about the first axis.

16. The LiDAR according to claim 1, further comprising a first housing, and a second housing spaced apart along the first axis, the first housing defining a first accommodation cavity, the second housing defining a second accommodation cavity, the first accommodation cavity and the second accommodation cavity being communicated; the laser transceiver module being accommodated in the second accommodation cavity, and the reflective assembly being accommodated in the first accommodation cavity.

17. The LiDAR according to claim 16, wherein the control unit comprises a turntable and controller accommodated in the second accommodation cavity, one end of the turntable is connected to the controller and other end of the turntable extends through the first accommodation cavity, the reflective assembly is fixed to the turntable; the controller is configured to control the rotation of the turntable about the first axis, with the first axis being an axis of the turntable.

18. The LiDAR according to claim 16, further comprising a processing component accommodated in the second accommodation cavity, the processing component being electrically coupled to the laser transceiver module, the processing component being configured to process the collimated laser beams and the reflected beams to form point cloud data.

19. The LiDAR according to claim 11, wherein the laser transceiver module includes a laser emitter and a multi-channel optical circulator, the multi-channel optical circulator defines a plurality of transmit channels and a plurality of receive channels; the multi-channel optical circulator includes a first multi-channel fiber collimator, and a second multi-channel fiber collimator, the original laser beams emitted by the laser emitter passing through the first multi-channel fiber collimator to form the plurality of collimated laser beams, the plurality of collimated laser beams are incident on the reflective element along the plurality of transmit channels, and the plurality of reflected beams are incident on the second multi-channel fiber collimator along the plurality of receive channels.

20. The LiDAR according to claim 19, wherein a number of the plurality of transmit channels equals a number of the plurality of receive channels, each transmit channel is paired with a corresponding receive channel in one-to-one correspondence, each transmit channel partially overlapping with the corresponding receive channel.
